(19) United States
(12) Patent Application Publication
(10) Pub. No.: US 2013/0177350 A1
(43) Pub. Date: Jul. 11, 2013

(54) MECHANICAL CONNECTION DEVICE FOR CONNECTING A LOAD TO A SUPPORT

(71) Applicant: WICHARD, Thiers (FR)

(72) Inventor: Mathieu GUIHARD, Saint Nazaire (FR)

(73) Assignee: WICHARD, Thiers (FR)

(21) Appl. No.: 13/738,559

(22) Filed: Jan. 10, 2013

(30) Foreign Application Priority Data
Jan. 10, 2012 (FR) 12/50235

(51) Int. Cl. F16B 17/00

(52) U.S. Cl. CPC F16B 17/00
USPC 403/322.1

(57) ABSTRACT

The connection device according to the invention comprises a first element (3) designed to be connected to the support and a second element (4) designed to be connected to the load. The second element (4) includes a tubular portion (9, 15) adapted to receive the first element (3), locking means (24) movable between locking and unlocking positions of the first and second elements (3, 4), a control ring (25) movable between a first position in which it immobilizes the locking means (24) in their locked position, and a second position in which it allows the locking means (24) to move toward their unlocked position, and a control button (42a, 42b) movable between a first position in which the control button cooperates with the tubular portion so as to immobilize the control ring (25) in its first position, and a second position in which it allows the control ring (25) to move toward its second position.

### TECHNICAL FIELD

The present invention relates to a mechanical connection device for connecting a load to a support, and more particularly for connecting an operator to support.

### BRIEF DESCRIPTION OF RELATED ART

To ensure the safety of a person moving for example on the deck of a boat or working at heights, in particular on the roof of a building or other structures, it is known to equip that person with a safety harness and to connect the safety harness to a support, such as an anchor point or a lifeline, by means of a tether provided, at least at one of its ends, with a safety snap hook designed to be connected to the support or the safety harness.

Thus, under optimal usage conditions, the person can rapidly and easily disconnect from the support by actuating the snap hook.

However, actuating the snap hook under a load may prove difficult or even impossible under certain usage conditions of the tether, for example when the person connected to the tether is helihoisted or is moving on the deck of the ship and falls above the deck, and even more so when the snap hook is a double-safety snap hook. This drawback may be very detrimental to the physical integrity of the person connected to the support.

In order to offset this drawback, the tether may be provided, at a first end, with a snap hook opening under a load designed to be connected to the safety harness, and, at a second end, with a safety snap hook designed to be connected to the support. Such a tether makes it possible to facilitate opening of the snap hook connected to the safety harness under a load, and therefore to facilitate the disconnection of the person wearing the safety harness.

However, under certain usage conditions, the opening of a snap hook under a load may also prove difficult if not impossible. Furthermore, snap hooks generally only have a single opening safety, making it impossible to use them in certain areas of activity.

### BRIEF SUMMARY

The present invention aims to resolve these drawbacks.

The technical problem at the base of the invention therefore consists of providing a mechanical connection device that has a simple and cost-effective structure, but allows quick and easy disconnection under a load, while having at least two opening safety levels.

To that end, the present invention relates to a mechanical connection device for connecting a load to a support, comprising a first element and a second element, one of the first and second elements being adapted to be connected to the support, the other of the first and second elements being adapted to be connected to the load, the second element including:
a tubular portion adapted to receive the first element,
locking means movably mounted on the tubular portion between a locking position of the first and second elements, and an unlocked position of the first and second elements,
a control ring movably mounted around the tubular portion between a first position in which the control ring immobilizes the locking means in their locked position, and a second position in which the control ring allows the locking means to move toward their unlocked position, and
at least one control button mounted on the control ring, the control button being movable relative to the control ring between a first position in which the control button cooperates with the tubular portion so as to immobilize the control ring in its first position, and a second position in which the control button allows the control ring to move toward its second position.

In this way, when the first and second elements are locked on each other, the control button prevents any unwanted movement of the control ring toward its second position, which prevents any untimely locking of the first element. As a result, the connection device according to the invention has double opening safety.

When the user wishes to unlock the first and second elements, he need only first move the control button into its second position, and then move the control ring into its second position. Such a manipulation of the second element under a load is quick and easy, including when the user is under less-than-optimal conditions, for example after a fall.

The support may for example be an anchor point, a lifeline or similar means, and the load may for example be an operator or cargo. According to one embodiment of the invention, the other of the first and second elements is adapted to be connected to a safety harness worn by the operator.

According to one embodiment of the invention, the first element includes a generally cylindrical fastening point designed to cooperate with the second element.

Advantageously, the control ring is slidingly mounted around the tubular portion substantially parallel to the axis of the tubular portion. The control button is then preferably slidingly secured to the control ring.

According to one embodiment of the invention, the control ring is mounted substantially fixed in rotation relative to the tubular portion.

The control button for example comprises a handling portion mounted in a lumen formed in the control ring. Advantageously, the lumen and the handling portion are configured to make the control button and the control ring slidingly integral. According to one embodiment of the invention, the lumen delimits at least one first and second wall arranged to cooperate respectively with a first and second wall of the handling portion so as to make the control button and the control ring slidingly integral. Preferably, the lumen receiving the control button is arranged to guide the control button during movements thereof between its first and second positions.

According to one embodiment of the invention, the controller is configured such that the control button is situated, in its second position, withdrawn relative to the outer surface of the control ring.

According to one embodiment of the invention, the second element comprises first and second control buttons angularly offset relative to one another, and for example opposite one another relative to the axis of the tubular portion.

According to one feature of the invention, when the control ring is in its second position, the control button is arranged to cooperate with the tubular portion so as to be immobilized in its second position.

Advantageously, the control button includes at least one retaining portion, and the tubular portion includes at least one guide track in which the retaining portion is movably mounted.

According to one embodiment of the invention, the guide track for example comprises at least one first guide portion arranged to cooperate with the retaining portion when the control ring is in its second position so as to immobilize the control button in its second position, and a second guide portion arranged to receive the retaining portion when the control ring is in its first position and to allow the control button to move toward its first position. The first guide portion may include a stop wall arranged to cooperate with the retaining portion so as to immobilize the control button in its second position. The second guide portion may include at least one first stop wall arranged to cooperate with the retaining portion so as to immobilize the control ring in its first position. Preferably, the second guide portion includes at least one second stop wall arranged to cooperate with the retaining portion so as to limit the travel of the control button toward its first position.

According to one embodiment of the invention, the first guide portion extends substantially parallel to the axis of the tubular portion. According to one embodiment of the invention, the second guide portion extends transversely from the first guide portion.

According to one embodiment of the invention in which the second element comprises first and second control buttons, the guide track is arranged to receive retaining portions of the first and second control buttons. In this way, the control track advantageously comprises a first guide portion arranged to cooperate with the respective retaining portions of the first and second control buttons when the control ring is in its second position so as to immobilize the first and second control buttons in their second position, a second guide portion arranged to receive the retaining portion of the first control button when the control ring is in its first position and to allow the first control button to move toward its first position, and a third guide portion arranged to receive the retaining portion of the second control button when the control ring is in its first position and to allow the second control button to move toward its first position. Preferably, the second and third portions extend opposite one another.

According to one embodiment of the invention, the control button includes two retaining portions, and the tubular portion includes two guide tracks angularly offset relative to one another, in each of which one of the retaining portions is movably mounted.

According to one embodiment of the invention, the control button can move between its first and second positions substantially radially relative to the control ring.

Preferably, the second element comprises first return means arranged to bias the control button toward its first position. The first return means for example include a generally U-shaped spring whereof the branches bear against the tubular portion and the base bears against the control button. The branches of the U can for example be fastened on the tubular portion.

Advantageously, the second element comprises second return means arranged to bias the control ring toward its first position.

According to one embodiment of the invention, the control ring includes at least one first portion having a first inner diameter and at least one second portion having a second inner diameter larger than the first diameter, the first portion being arranged to cooperate with the locking means and immobilize said means in their locking position when the control ring is in its first position, the second portion being arranged to allow the locking means to move toward their unlocked position when the control ring is in its second position.

Preferably, the locking means include at least one locking member mounted in a through bore formed in the tubular portion of the second element, and movable between a locked position in which it cooperates with the first element so as to lock the first and second elements on one another, and an unlocked position.

The at least one locking member may for example be a friction ball or a locking pad. The at least one locking member is advantageously radially movable between its locked and unlocked positions.

Preferably, the at least one locking member in the locked position protrudes inside the tubular portion and the at least one locking member in the unlocked position does not protrude inside the tubular portion.

According to one embodiment of the invention, the locking means include a plurality of locking members each mounted in a through bore formed the tubular portion of the second element, each locking member being movable between a locked position in which it cooperates with the first element so as to lock the first and second elements on each other, and an unlocked position.

The locking means may for example include a first series of locking members and a second series of locking members axially offset relative to one another.

According to one embodiment of the invention, the second element includes a locking ring movably mounted in the tubular portion between a first position, in which the locking ring cooperates with at least one locking member so as to block said at least one locking member in its unlocked position, and a second position, in which the locking ring allows said at least one locking member to move toward its locked position, said at least one locking member, in the unlocked position, being arranged to cooperate with the control ring so as to immobilize the control ring in its second position, and said at least one locking member, in the locked position, being arranged to release the control ring and allow the control ring to move toward its first position. The locking ring may be slidingly mounted in the tubular portion substantially parallel to the axis of the tubular portion.

The second element advantageously comprises third return means arranged to bias the locking ring toward its first position.

Preferably, the first element includes an actuating portion arranged to cooperate with the locking ring and to move the latter toward its second position when the tubular portion receives the first element.

According to one embodiment of the invention, the first element includes at least one annular groove adapted to receive the locking means in the locked position of the first and second elements. The first element may for example include first and second annular grooves axially offset relative to one another, and the locking means may for example include a first series of locking members and a second series of locking members axially offset relative to one another, the locking members of the first series being arranged to be received in the first annular groove and the locking members of the second series being arranged to be received in the second annular groove.

Preferably, the locking ring is arranged to cooperate with the locking members of the first series.

According to one embodiment of the invention, the control ring includes at least one inclined ramp formed on the inner surface of the control ring and arranged to bias the locking means toward their locked position during the movement of the control ring toward its first position.

According to a first alternative embodiment of the invention, the tubular portion includes a tubular body on which the locking means are mounted, and a guide ring fastened substantially coaxially on the tubular body, the control button being arranged to cooperate, in its first position, with the guide ring so as to immobilize the control ring in its first position.

Advantageously, the guide track is formed on the guide ring.

According to one embodiment of the invention, the second return means include at least one return spring, for example helical, bearing on the one hand on the guide ring and on the other hand on the control ring. Preferably, the guide ring comprises at least one housing arranged to receive the return spring at least partially.

According to one embodiment of the invention, the guide ring is formed by first and second half-rings fastened on one another, for example by means of at least one lug formed on one of the first and second half-rings and arranged to be housed in a complementary housing provided on the other of the first and second half-rings.

According to a second alternative embodiment of the invention, the tubular portion may be formed by a single-piece tubular body.

According to one embodiment of the invention, the control ring is formed by first and second half-rings fastened on one another, for example by means of at least one lug formed on one of the first and second half-rings and arranged to be housed in a complementary housing provided on the other of the first and second half-rings.

The second element advantageously includes stop means arranged to limit the travel of the control ring toward its first position, and preferably stop means arranged to limit the travel of the locking ring toward its first position.

Preferably, the control ring comprises at least one reinforcing annulus, for example made from metal, arranged to cooperate with the locking means when the control ring is in its first position.

### BRIEF DESCRIPTION OF THE DRAWINGS

In any case, the invention will be well understood using the following description and in reference to the appended diagrammatic drawing showing, as non-limiting examples, two embodiments of this mechanical connecting device.

FIG. 1 is an exploded perspective view of a mechanical connection device according to the invention.

FIG. 2 is a perspective view of the mechanical connection device of FIG. 1 under usage conditions.

FIG. 3 is a perspective view of the mechanical connection device of FIG. 1 in the unlocked position.

FIG. 4 is a transverse cross-sectional view of the mechanical connection device of FIG. 1 in the unlocked position.

FIGS. 5 and 6 are longitudinal cross-sectional views of the mechanical connection device of FIG. 1 in the unlocked position.

FIG. 7 is a perspective view of the mechanical connection device of FIG. 1 in the locked position.

FIGS. 8 and 9 are longitudinal cross-sectional views of the mechanical connection device of FIG. 1 in the locked position.

FIG. 10 is a transverse cross-sectional view of the mechanical connection device of FIG. 1 in the locked position.

FIG. 11 is a perspective view of a half-ring forming a guide ring of the mechanical connection device of FIG. 1.

FIG. 12 is a longitudinal cross-sectional view of a mechanical connection device according to a second embodiment of the invention.

### DETAILED DESCRIPTION

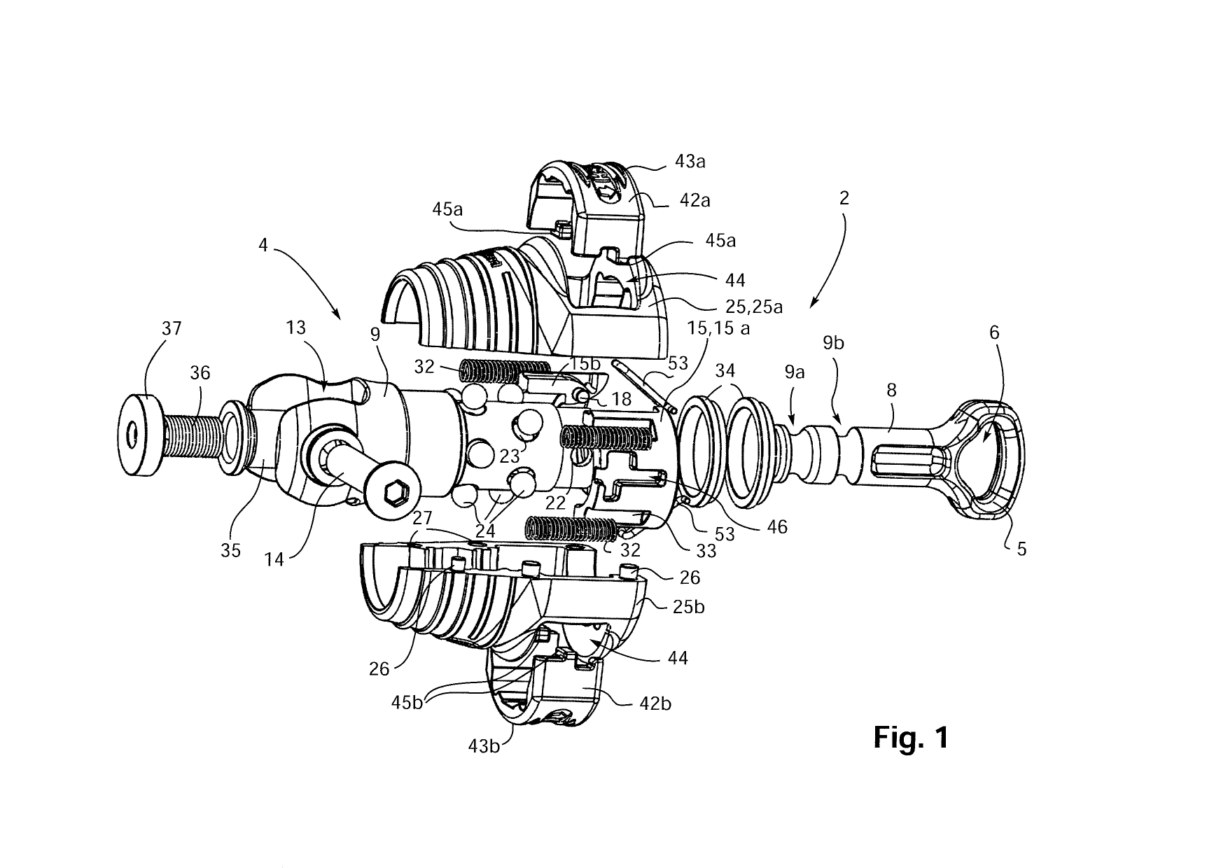

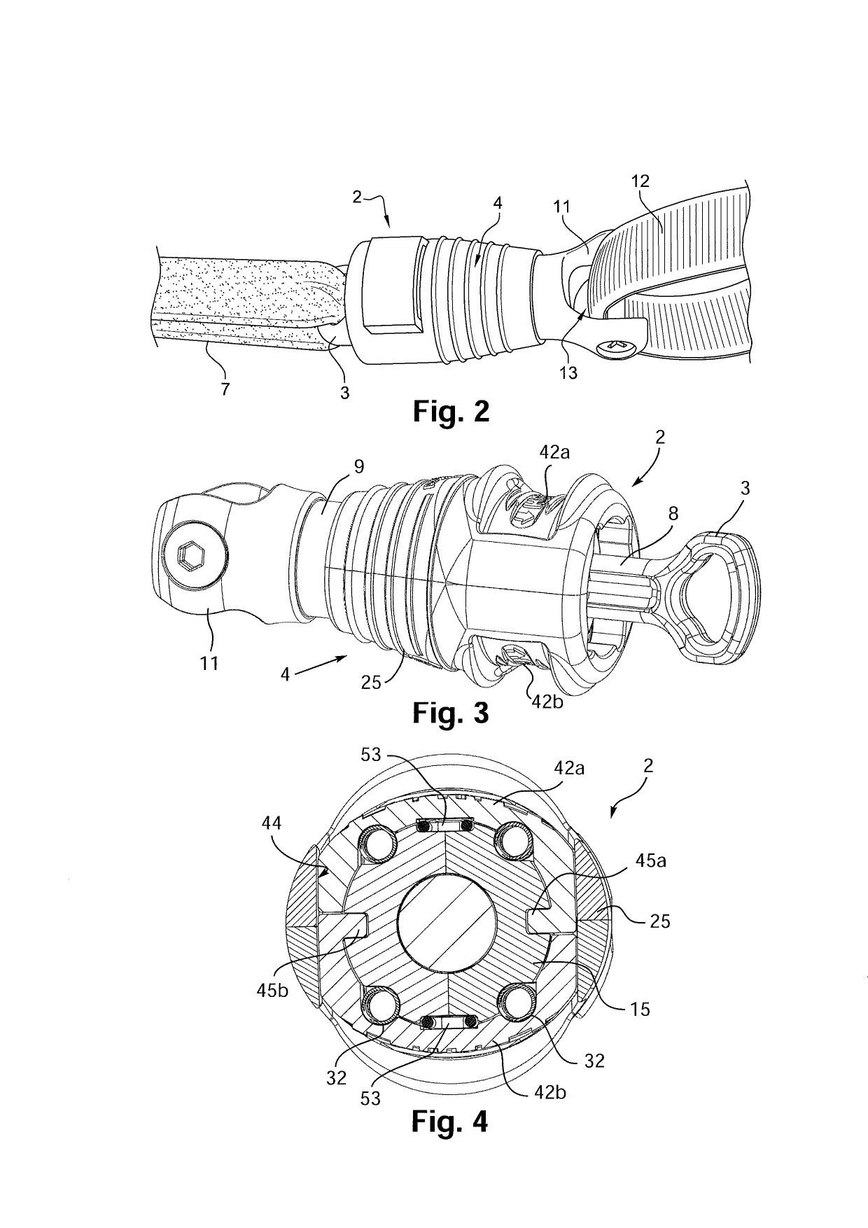

FIGS. 1 to 10 show a mechanical connection device 2 for connecting a load to a support according to a first embodiment of the invention. The mechanical connection device 2 includes a first element 3 designed to be connected to a support, such as an anchor point, a lifeline or similar device, and a second element 4 designed to be connected to a load, such as an operator or cargo. The second element 4 is more particularly designed to be connected to a safety harness worn by the operator.

The first element 3 includes an assembly portion 5 provided with an assembly eyelet 6 designed for assembling a mechanical link 7, such as a rope or strap, directly or indirectly connected to the support. The first element 3 also includes a generally cylindrical fastening portion 8 designed to cooperate with the second element 4. The fastening portion 8 includes first and second annular grooves 9a, 9b axially offset relative to one another.

The second element 4 includes a tubular body 9 comprising an assembly portion 11 designed to assemble a mechanical link 12, such as a rope or strap, directly or indirectly connected to the load. The assembly portion 11 for example includes a grommet 13 and a threaded rod 14 movable between a closed position, in which the threaded rod closes the grommet, and an open position, in which the threaded rod makes the grommet accessible.

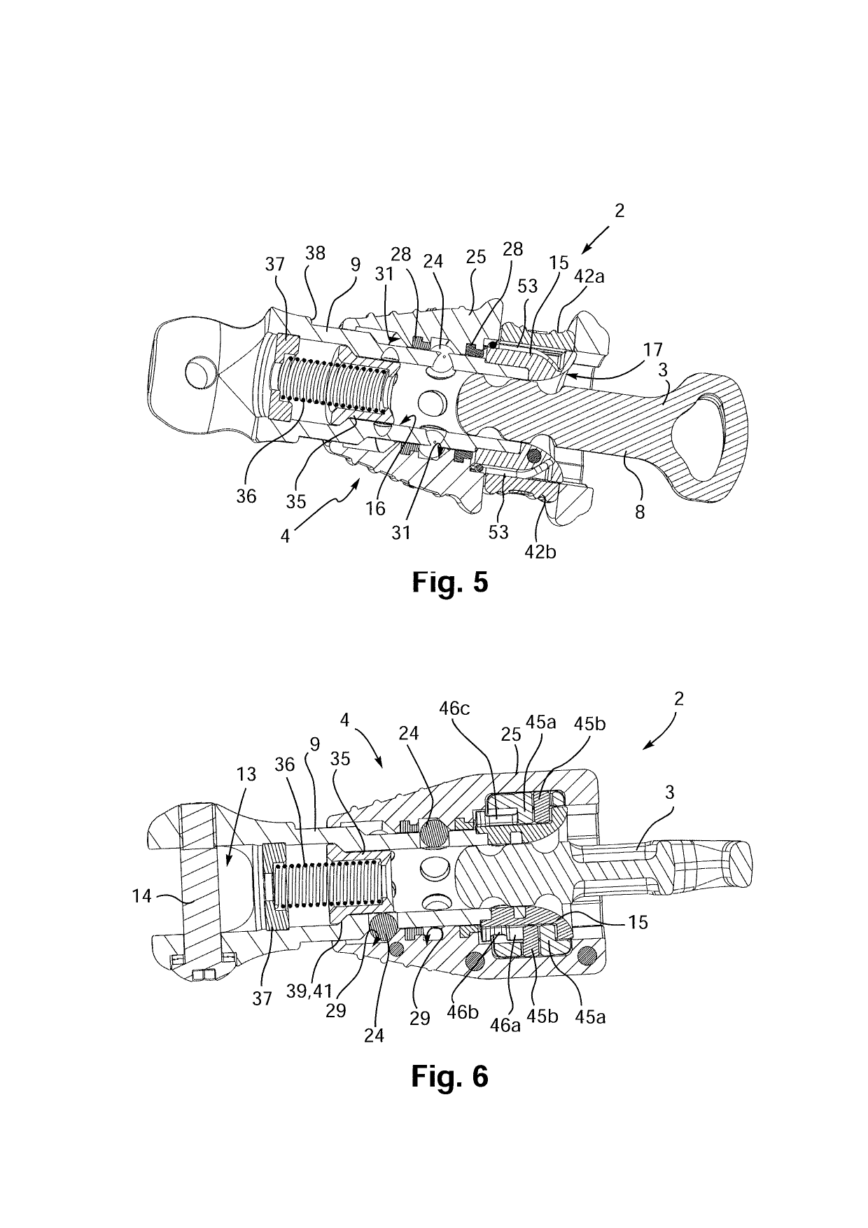

The second element 4 also includes a guide ring 15 fastened coaxially on the tubular body 9. The tubular body 9 and the guide ring 15 delimit a fastening duct 16 adapted to receive the fastening portion 8 of the first element 3. As shown more particularly in FIG. 5, the guide ring 15 advantageously comprises a third portion 17 so as to facilitate the insertion of the fastening portion 8 of the first element 3 into the fastening duct 16.

According to one embodiment of the invention, the guide ring 15 is made up of two half-rings 15a, 15b fastened on one another. As shown in FIGS. 1 and 8, each half-ring 15a, 15b for example includes a first fastening lug 18 arranged to be housed in a complementary housing 19 provided on the other half-ring. As shown in particular in FIG. 10, each half-ring 15a, 15b also includes a second fastening lug 21 arranged to be housed in a complementary housing 22 provided on the tubular body 9.

The tubular body 9 includes several bores 23 formed radially through the wall of the tubular body 9. Each bore 23 forms a housing for a friction ball 24. The second element 4 more particularly includes a first series of friction balls 24 and a second series of friction balls 24 axially offset relative to each other.

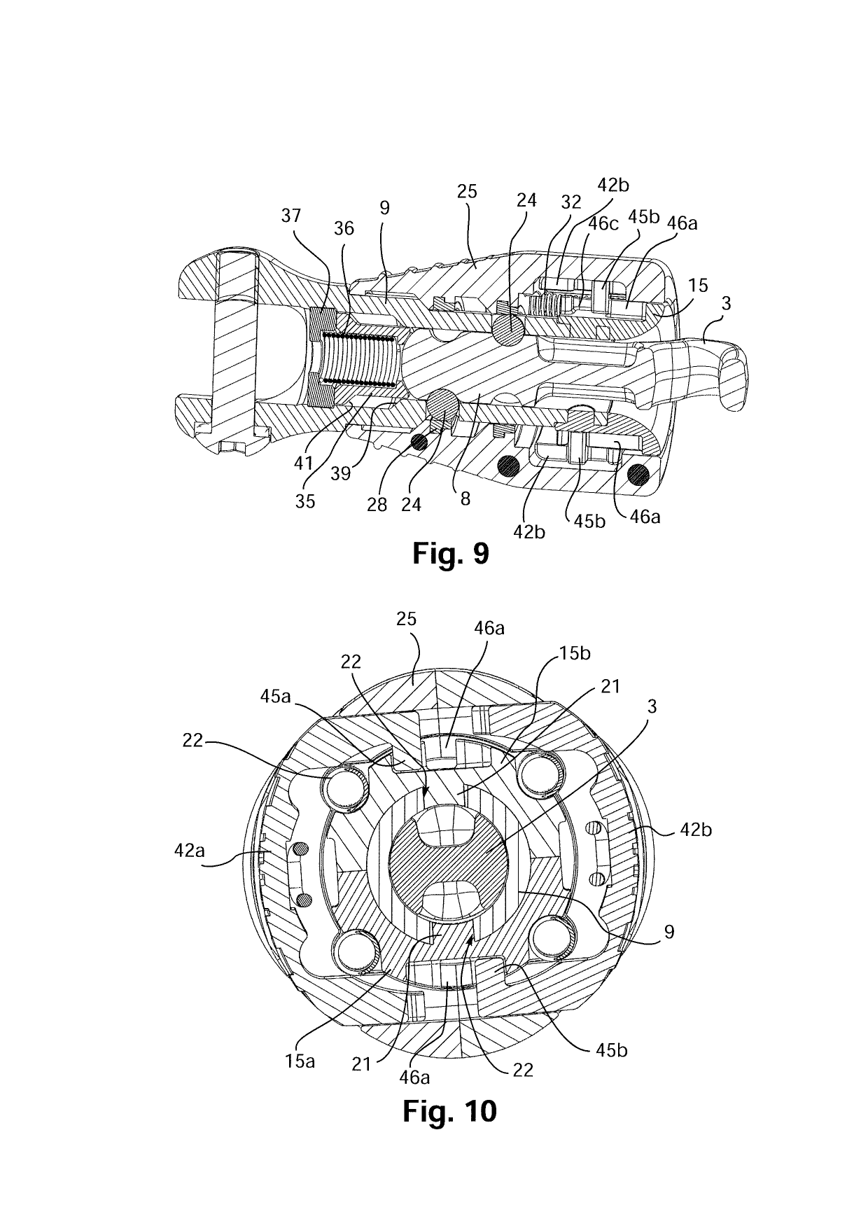

Each friction ball 24 is radially movable between a locked position (shown in FIGS. 8 and 9), in which it protrudes inside the tubular body 9, and an unlocked position (shown in FIGS. 5 and 6), in which it does not protrude inside the tubular body 9. The friction balls 24 of the first series are designed to be received, in the locked position, in the first annular groove 9a formed on the fastening portion 8 of the first element 3, while the friction balls 24 of the second series are designed to be received, in the locked position, in the second annular groove 9b formed on the fastening portion 8 of the first element 3.

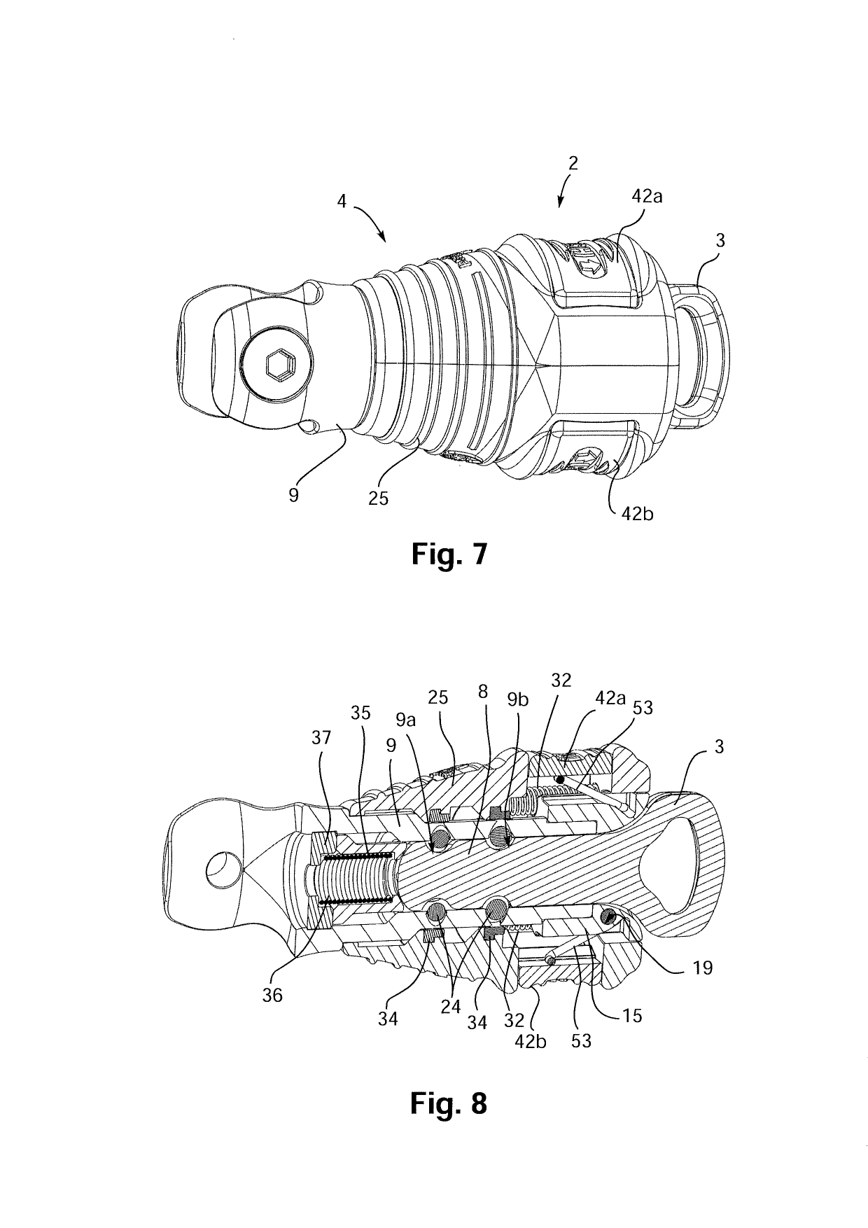

The second element 4 also includes a control ring 25 slidingly mounted around the tubular body 9 and the guide ring 15 along the axis of the tubular body 9 between a first position (shown in FIGS. 7 to 9), wherein the control ring 25 biases each friction ball 24 toward its locking position, and a second position (shown in FIGS. 3, 5 and 6), in which the control ring 25 allows each friction ball 24 to move toward its unlocked position. The control ring 25 is preferably mounted substantially fixed in rotation relative to the tubular body 9.

According to one embodiment of the invention, the control ring 25 is made up of two half-rings 25a, 25b fastened on each other. Each half-ring 25a, 25b for example includes several fastening lugs 26 arranged to be housed respectively in complementary housings 27 provided on the other half-ring.

The control ring 25 includes, on the inner surface thereof, two annular ribs 28 axially offset relative to one another, and two annular grooves 29 axially offset relative to one another. As shown in FIGS. 8 and 9, the axial ribs 28 are arranged to cooperate with the friction balls 24 and to immobilize said friction balls in the locked position when the control ring 25 is in its first position. As shown in FIGS. 5 and 6, the annular grooves 29 are arranged to allow the friction balls 24 to move toward their unlocked position when the control ring 25 is in its second position.

The control ring 25 also includes two inclined ramps 31 formed on the inner surface of the control ring 25 and respectively arranged between one of the annular grooves 29 and one of the annular ribs 28. Each inclined ramp 31 is arranged to bias the corresponding friction balls 24 toward the locked position during the movement of the control ring 25 toward its first position.

The second element 4 also includes a plurality of return springs 32, preferably helical springs, arranged to bias the control ring 25 toward its first position. Each return spring 25 includes a first end bearing against the guide ring 15, and a second end bearing against the control ring 25. The guide ring 25 preferably comprises a plurality of housings 33 formed on its outer surface and arranged each to partially receive one of the return springs 32.

According to one embodiment not shown in the figures, the return springs 32 may be replaced by a single helical return spring mounted on the guide ring 15 and/or the tubular body 9.

Preferably, the control ring 25 comprises two reinforcing annuluses 34, for example made from metal, arranged to cooperate with the friction balls 24 when the control ring 25 is in its first position, and partially formed from the annular ribs 28.

The second element 4 also includes a locking ring 35 slidingly mounted in the tubular body 9 along the axis thereof between a first position (shown in FIGS. 5 and 6), in which the locking ring 35 biases each friction ball 24 of the first series toward its unlocked position, and a second position (shown in FIGS. 8 and 9) in which the locking ring 35 allows each friction ball 24 of the first series to move toward its locked position.

The second element 4 also includes a return spring 36, preferably a helical spring, arranged to bias the locking ring 35 toward its first position. The return spring 36 includes a first end bearing against a bearing member 37 fixed in translation along the axis of the tubular body 9, and a second end bearing against the locking ring 35. The bearing member 37 can be fastened on the tubular body 9, for example by gluing or screwing, or may be forcibly mounted therein.

It should be noted that the friction balls 24 of the first series are arranged on the one hand to immobilize the control ring 25 in its second position when the locking ring 35 is in its first position, and on the other hand to release the control ring 25 when the locking ring 35 is moved toward its second position.

The second element 4 includes first stop means arranged to limit the travel of the control ring 25 toward its first position, and second stop means arranged to limit the travel of the locking ring 35 toward its first position. The first stop means include a shoulder 38 formed on the outer surface of the tubular body 9 and arranged to cooperate with an end wall of the control ring 25. The second stop means include a shoulder 39 formed on the inner surface of the tubular body 9 and arranged to cooperate with the complementary shoulder 41 formed on the outer surface of the locking ring 35.

The second element 4 also comprises first and second control buttons 42a, 42b angularly offset relative to one another, and for example opposite one another relative to the axis of the tubular body 9.

Each control button 42a, 42b comprises a handling portion 43a, 43b mounted in a lumen 44 formed in the control ring 25. Handling portions 43a, 43b of the control buttons 42a, 42b and the corresponding lumens 44 are configured to make the control buttons 42a, 42b and the control ring 25 slidingly integral.

Each control button 42a, 42b is radially movable relative to the control ring 25 between a first position (shown in FIGS. 7 to 9), in which the control button 42a, 42b cooperates with the guide ring 15 so as to immobilize the control ring 25 in its first position, and a second position (shown in FIGS. 3, 5 and 6), in which the control button 42a, 42b allows the control ring 25 to move toward its second position. Preferably, each lumen 44 is arranged to guide the corresponding control button 42a, 42b during the movements of the latter part between its first and second positions.

As shown in FIGS. 5 and 6, the control ring 25 is advantageously configured such that each control button 42a, 42b is situated withdrawn relative to the outer surface of the control ring when it is in its second position. Each control button 42a, 42b also includes two retaining fingers 45a, 45b that are axially offset relative to one another, turned toward one another and extending substantially parallel to one another. The guide ring 15 comprises two guide tracks 46 formed on its outer surface and angularly offset relative to one another. Each guide track 46 is arranged to receive one of the retaining fingers 45a, 45b of each control button 42a, 42b.

Each control track 46 advantageously comprises a first guide portion 46 arranged to cooperate with the respective retaining fingers 45a, 45b of the control buttons 42a, 42b when the control ring 25 is in its second position (as shown in FIG. 6) so as to immobilize the two control buttons 42a, 42b in their second position, a second guide portion 46 arranged to receive the respective retaining finger 45a of the first control button 42a when the control ring 25 is in its first position and to allow the first control button 42a to move toward its first position, and a third guide portion 46c arranged to receive the respective retaining finger 45b of the second control button 42b when the control ring 25 is in its first position and to allow the second control button 42b to move toward its first position. Preferably, the second and third guide portions 46b, 46c of each guide track 46 extend opposite one another.

The first guide portion 46a of each guide track 46 includes a stop wall 47 arranged to cooperate with the respective retaining finger 45a, 45b of each control button 42a, 42b so as to immobilize the control buttons 42a, 42b in their second position. The second and third guide portions 46b, 46c of each guide track 46 advantageously each include a first stop wall 48, 49 arranged to cooperate with the retaining finger 45a, 45b of the respective control button 42a, 42b so as to immobilize the control ring 25 in its first position. Preferably, the second and third guide portions 46b, 46c of each guide track 46 each include a second stop wall 51, 52 arranged to cooperate with the retaining finger 45a, 45b of the respective control button 42a, 42b so as to limit the travel of the respective control button 42a, 42b, toward its first position.

The first guide portion 46a of each guide track 46 extends substantially parallel to the axis of the tubular body 9, and the second and third guide portions 46b, 46c of each guide track 46 extend substantially perpendicular from the first respective guide portion 46a.

The second element 4 also comprises a return spring 53 associated with each control button 42a, 42b and arranged to bias the respective control button 42a, 42b toward its first position. Each return spring 53 for example is generally

U-shaped, the branches of the U bearing against the outer surface of the guide ring 15 and the base of the U bearing against the respective control button 42a, 42b.

The operation of the connection device 2 will now be described below, assuming that initially, the locking ring 35 is in its first position, the friction balls 24 of the first series are in their unlocked position, the control ring 25 is in its second position, the control buttons 42a, 42b are in their second position, the retaining fingers 45a, 45b of the control buttons are received in the first guide portions 46a of the respective guide tracks 46, and the first and second elements 3, 4 are unlocked. In this initial situation, the status of the connection device is that illustrated by FIGS. 3 to 6.

When the user wishes to lock the first element 3 on the second element, he inserts the fastening portion 8 of the first element 3 into the fastening duct 16 of the second element 4. During this insertion of the fastening portion 8 into the fastening duct 16, the free end of the fastening portion 8 comes into contact against the locking ring 35, and then moves the locking ring 35 toward its second position against the return force exerted by the return spring 36.

The insertion of the fastening portion 8 in the fastening duct 16 continues until the friction balls 24 of the first and second series are opposite the respective annular grooves 9a, 9b and are pushed radially into the respective annular grooves by the corresponding inclined ramps 31 of the control ring 25. Such a movement of the friction balls 24 toward the annular grooves 9a, 9b causes a release of the control rings 25, which is then biased toward its first position by the return springs 32.

During the movement of the control ring 25 toward its first position, the control buttons 42a, 42b are driven with the latter part and the retaining fingers 45a, 45b of the control buttons 42a, 42b slide in the first guide portions 46a of the respective guide tracks 46.

When the control ring 25 abuts against the shoulder 38 formed on the tubular body 9, the annular ribs 28 of the control ring 25 cooperate with the friction balls 24 and immobilize the latter in their locked position, as shown in FIGS. 8 and 9. This results in locking the first and second elements.

Furthermore, when the control ring 25 abuts against the shoulder 38 formed on the tubular body 9, the retaining fingers 45a, 45b of the control buttons 42a, 42b are across from the second and third guide portions 46b, 46c of the respective guide tracks. Each control button 42a, 42b is then biased toward its first position by the respective return spring 53.

When a user wishes to unlock the first element 3, he first exerts pressure on each control button 42a, 42b so as to move them into their second position, such that the retaining fingers 45a, 45b of the control buttons 42a, 42b are located across from the first guide portions 46a of the respective guide tracks 46, and he secondly moves the control ring 25 axially toward its second position. The friction balls 24 of the first and second series are then located respectively across from the first and second annular grooves 29 of the control ring 25 and are therefore free to move toward their unlocked position. The friction balls 24 are then pushed radially back toward their unlocked position by the first element 3. This results in unlocking the first element 3 and the possibility of removing the first element 3 from the fastening duct 16.

When the first element 3 is removed from the fastening duct 16, the locking ring 35 is biased by the return spring 36 toward its first position and blocks the friction balls 24 of the first series in their unlocked position so as to immobilize the control ring 25 in its second position.

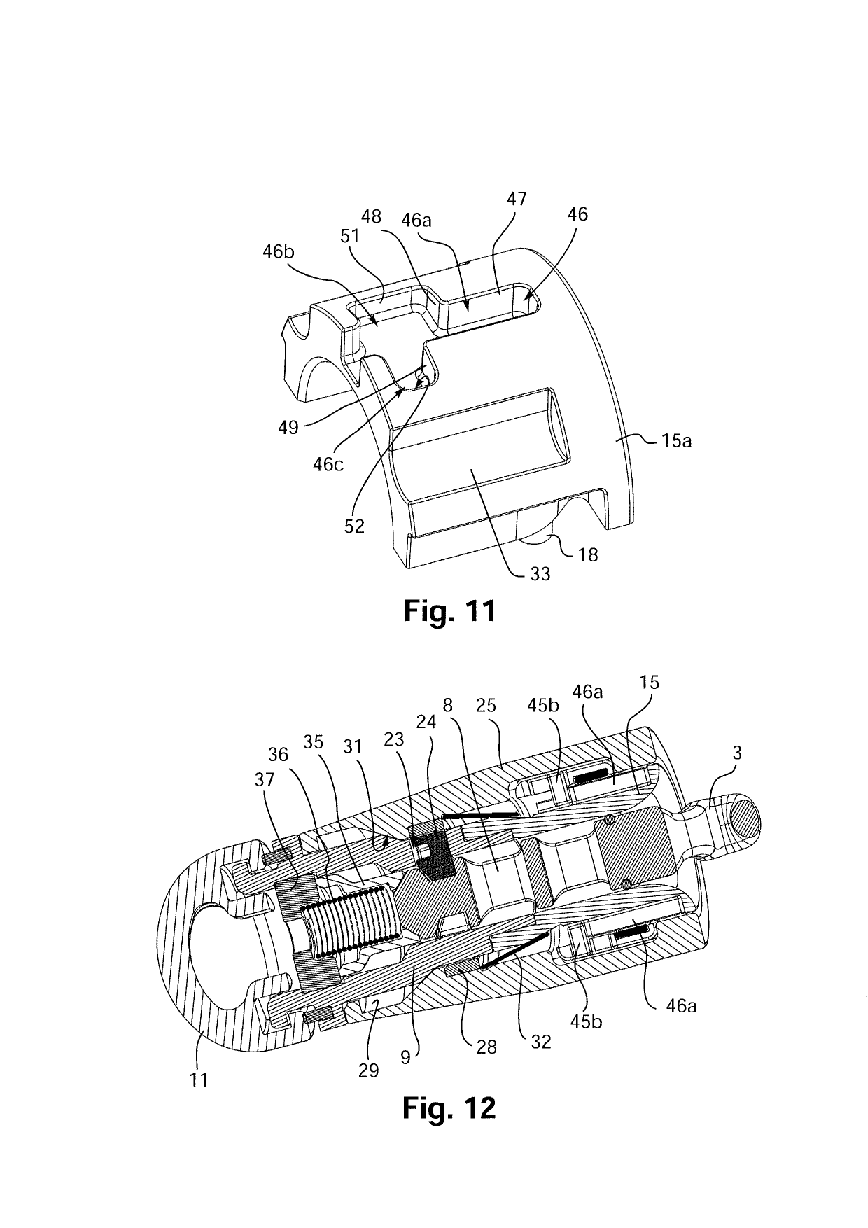

FIG. 12 shows a mechanical connection device 2 according to a second embodiment of the invention different from that shown in FIGS. 1 to 11 essentially in that the friction balls 24 are replaced by blocking pads 24 mounted radially sliding in the bores 23 formed the tubular body 9, in that the control ring 25 includes a single series of blocking pads 24, and in that the assembly portion 11 is mounted removably relative to the tubular body 9. In particular, the assembly portion 11 is rotatably movable relative to the tubular body 9 between a position fastening the assembly portion on the tubular body 9 and a disassembled position of the assembly portion.

According to another embodiment of the invention, the first element 3 may be connected to the load and the second element may be connected to the support.

The invention is of course not limited solely to the embodiments of this mechanical connection device described above as examples; on the contrary, it encompasses all alternative embodiments.

1. A mechanical connection device (2) for connecting a load to a support, comprising a first element (3) and a second element (4), one of the first and second elements being adapted to be connected to the support, the other of the first and second elements being adapted to be connected to the load, the second element (4) including:
a tubular portion (9, 15) adapted to receive the first element (3),
locking means (24) movably mounted on the tubular portion between a locking position of the first and second elements (3, 4), and an unlocked position of the first and second elements (3, 4),
a control ring (25) movably mounted around the tubular portion (9, 15) between a first position in which the control ring (25) immobilizes the locking means (24) in their locked position, and a second position in which the control ring (25) allows the locking means (24) to move toward their unlocked position, and
at least one control button (42a) mounted on the control ring (25), the control button (42a) being movable relative to the control ring (25) between a first position in which the control button cooperates with the tubular portion so as to immobilize the control ring (25) in its first position, and a second position in which the control button allows the control ring (25) to move toward its second position.

2. The connection device according to claim 1, wherein the control ring (25) is slidingly mounted around the tubular portion (9, 15) substantially parallel to the axis of the tubular portion.

3. The connection device according to claim 2, wherein the control button (42a) is slidingly secured to the control ring (25). 30

4. The connection device according to claim 1, wherein the control button (42a) comprises a handling portion (43a) mounted in a lumen (44) formed in the control ring (25).

5. The connection device according to claim 1, wherein, when the control ring (25) is in its second position, the control button (42a) is arranged to cooperate with the tubular portion (9, 15) so as to be immobilized in its second position.

6. The connection device according to claim 1, wherein the control button (42a) includes at least one retaining portion (45a), and the tubular portion (9, 15) includes at least one guide track (46) in which the retaining portion (45a) is movably mounted.

7. The connection device according to claim 6, wherein the guide track (46) comprises at least one first guide portion (46a) arranged to cooperate with the retaining portion (45a) when the control ring (25) is in its second position so as to immobilize the control button (42a) in its second position, and a second guide portion (46b) arranged to receive the retaining portion (45a) when the control ring (25) is in its first position and to allow the control button (42a) to move toward its first position.

8. The connection device according to claim 7, wherein the first guide portion (46a) includes a stop wall (47) arranged to cooperate with the retaining portion (45a) so as to immobilize the control button (42a) in its second position.

9. The connection device according to claim 7, wherein the second guide portion (46b) includes at least one first stop wall (48) arranged to cooperate with the retaining portion (45a) so as to immobilize the control ring (25) in its first position.

10. The connection device according to claim 1, wherein the second element (4) comprises first return means (53) arranged to bias the control button (42a) toward its first position.

11. The connection device according to claim 1, wherein the second element (4) comprises second return means (32) arranged to bias the control ring (25) toward its first position.

12. The connection device according to claim 1, wherein the locking means include at least one locking member (24) mounted in a through bore (23) formed in the tubular portion (9, 15) of the second element, and movable between a locked position in which it cooperates with the first element (3) so as to lock the first and second elements on one another, and an unlocked position.

13. The connection device according to claim 12, wherein the second element (4) includes a locking ring (35) movably mounted in the tubular portion (9, 15) between a first position, in which the locking ring (35) cooperates with at least one locking member (24) so as to block said at least one locking member (24) in its unlocked position, and a second position, in which the locking ring (35) allows said at least one locking member (24) to move toward its locked position, said at least one locking member, in the unlocked position, being arranged to cooperate with the control ring (25) so as to immobilize the control ring (25) in its second position, and said at least one locking member, in the locked position, being arranged to release the control ring (25) and allow the control ring (25) to move toward its first position.

14. The connection device according to claim 13, wherein the first element (3) includes an actuating portion (8) arranged to cooperate with the locking ring (35) and to move the latter toward its second position when the tubular portion (9, 15) receives the first element (3).

15. The connection device according to claim 1, wherein the tubular portion includes a tubular body (9) on which the locking means (24) are mounted, and a guide ring (15) fastened substantially coaxially on the tubular body (9), the control button (42a) being arranged to cooperate, in its first position, with the guide ring (15) so as to immobilize the control ring (25) in its first position.
